(19) United States
(12) Patent Application Publication
(10) Pub. No.: US 2018/0371765 A1
(43) Pub. Date: Dec. 27, 2018

(54) FLOOR COVERING CONTAINING THERMOPLASTIC ELASTOMER AND METHOD FOR PRODUCING SAME

(71) Applicant: NORA SYSTEMS GMBH, Weinheim (DE)

(72) Inventors: Paul ADAMETZ, Mannheim (DE); Hanna SCHUELE, Heppenheim (DE); Mario KROEGER, Bruchsal (DE)

(21) Appl. No.: 16/065,219

(22) PCT Filed: Dec. 16, 2016
(86) PCT No.: PCT/EP2016/081492

§ 371 Date: Jun. 22, 2018

(30) Foreign Application Priority Data
Dec. 22, 2015 (DE) 10 2015 122 532.8

(51) Int. Cl. E04F 15/10; C08L 23/08; B32B 27/30; B32B 27/32; B32B 27/08

(52) U.S. Cl. CPC E04F 15/105; C08L 23/0815; E04F 15/107; B32B 27/302; B32B 2323/046; B32B 27/08; B32B 2471/00; B32B 2250/03; B32B 27/32

(57) ABSTRACT

The invention relates to a floor covering containing a polymer composition comprising a mixture of a component A, a component B and a component C, component A comprising an olefin-based polymer, component B comprising a polymer and component C comprising a styrene-based thermoplastic elastomer. The invention is characterised in that the polymer of component B comprises acid groups and/or anhydride groups which are grafted onto the polymer. The invention further relates to a method for manufacturing a floor covering of this type.

The present invention relates to a floor covering containing a polymer composition which comprises a mixture of a component A, a component B and a component C, component A comprising an olefin-based polymer, component B comprising a polymer and component C comprising a styrene-based thermoplastic elastomer. The invention further relates to a method for manufacturing a floor covering of this type.

Floor coverings containing thermoplastic elastomers are known. For example, EP 1 793 032 B1 discloses a floor covering which comprises a mixture of three polymers. Therein, different thermoplastic elastomers are also proposed as a constituent of the mixture. Styrene-based thermoplastic elastomers are also mentioned.

A thermoplastic floor covering is known from WO 2011/063849 A1. The floor covering described herein comprises a polymer matrix which includes an olefin-based polymer and a polymer comprising acid anhydride groups. The olefin-based polymer may be an olefin-based elastomer.

WO 2014/005631 A1 discloses a PVC-free floor covering comprising a plurality of layers. The floor covering includes a thermoplastic mixture which includes an olefin-based polymer, an anhydride copolymer and a filler.

JP 2002276141 discloses a floor covering which contains a mixture of a harder polyethylene polymer, a softer polyethylene polymer and a thermoplastic elastomer.

Tests have shown that the known floor coverings still do not have satisfactory strength values when adhered to the subfloor.

It is therefore an object of the invention to specify a floor covering containing a thermoplastic elastomer which has good strength values and simultaneously good mechanical resistance when adhered to the subfloor. A further object of the invention is to specify a method for manufacturing a floor covering of this type.

In a floor covering of the type mentioned at the outset, the object is achieved in that the polymer of component B comprises acid groups and/or anhydride groups which are grafted onto the polymer.

It has been found that in this way a resilient floor covering can be obtained which has good strength values, in particular good peel strength, when adhered. Further, the floor covering also has good mechanical and chemical resistance. The floor covering is in particular resistant to wear, and has a good abrasion resistance. In particular, a floor covering of this type can be used even under increased stresses such as occur in public buildings. The floor covering is easy to lay and easy to clean. In addition, it is dimensionally stable and resistant to cigarette burns. The pollution from emissions is very low. The floor covering is additionally colour-fast.

The object is achieved in a method for manufacturing a floor covering comprising the following steps:
providing a component A, a component B and a component C, component A comprising an olefin-based polymer, component B comprising a polymer in which acid groups and/or anhydride groups are grafted onto the polymer, and component C comprising a styrene-based thermoplastic elastomer;
manufacturing a polymer composition by mixing component A, component B and component C in a mixer;
shaping the polymer composition into a web.

The method makes it possible to manufacture a high-quality floor covering which has good adhesive properties and is further resistant to wear and ageing. Further, the manufacture is possible in a reliable and cost-effective manner. In addition, the floor coverings have few or no bubbles.

Hereinafter, further features of the invention are disclosed. These features relate both to the floor covering and to the method for manufacture.

A preferred embodiment provides that the styrene-based thermoplastic elastomer comprises a hard phase and a soft phase, and that the soft phase has a glass transition temperature T_{G} of −50° C. or higher. These measures contribute to good adhesive properties of the floor covering and high stability. The soft phase determines in particular the rubber-elastic properties of component C. The hard phase is responsible in particular for the dimensional stability and the strength of the material. The hard phase is additionally decisive as to the thermoplastic properties of the thermoplastic elastomer. Preferably, the glass transition temperature T_{G} of the soft phase is above −40° C. It is further preferred for the glass transition temperature T_{G} of the soft phase to be below +10° C. Particularly preferably, the glass transition temperature T_{G} of the soft phase is between −15° C. and +10° C. The hard phase preferably has a glass transition temperature T_{GH} of over +90° C. Component C may in particular comprise a block copolymer, at least one block forming the soft phase and at least one further block forming the hard phase. For example, in SBS, the styrene forms the hard phase whilst the butadiene forms the soft phase. In SEBS, the styrene forms the hard phase whilst the ethylene butylene forms the soft phase. In SIS, the styrene forms the hard phase and the isoprene forms the soft phase. The glass transition temperatures are determined by the differential scanning calorimetry as per DIN EN ISO 11357-2, version valid as of 1 Jul. 2015. The values stated in the present application were all determined by the half-step-height method.

A preferred embodiment provides that component C comprises an isoprene monomer built in the polymer chain as 1,2-vinyl isomer. In this case, particularly advantageous results can be achieved. This applies in particular even if the styrene content of component C is in the range of between 15 and 40% by weight. Preferably, more than 30% of the isoprene monomers are built in the polymer chain as 1,2-vinyl isomers. Particularly preferably, more than 50% of the isoprene monomers are built in the polymer chain as 1,2-vinyl isomers. It has been found to be particularly advantageous in certain cases if more than 70% of the isoprene monomers are built in the polymer chain as 1,2-vinyl isomers. In particular, the 1,2-vinyl isomer may be part of the soft phase. These measures contribute to good adhesive properties of the floor covering and high stability. In addition, they make it possible to achieve a glass transition temperature T_{G} of the soft phase in the preferred range.

Advantageously, it may be provided that the soft phase of component C comprises styrene. Preferably, the soft phase may comprise a styrene/butadiene block. This may for example be the case if component C comprises a SBS of the structure S-(S/B)-S, S representing a polystyrene block and S/B representing a styrene/butadiene copolymer block. Preferably, the styrene content of the soft phase is more than 30% by weight based on the soft phase. Preferably, the styrene butadiene block (S/B) consists of 15 to 70% by weight styrene and 30 to 85% by weight butadiene. These measures contribute to good adhesive properties of the floor covering and high stability.

A further improvement provides that component C has a styrene content of between 15% by weight and 80% by weight. Preferably, the styrene content is more than 30% by weight. A styrene content of component C of more than 40% by weight is particularly preferred. This contributes to good adhesive properties of the floor covering and high stability.

A preferred embodiment of the invention provides that the styrene-based thermoplastic elastomer of component C comprises at least one compound from the group consisting of styrene-butadiene-styrene block copolymers (SBS), styrene-isoprene-styrene block copolymers (SIS), styrene-ethylene-butylene-styrene block copolymers (SEBS) and styrene-ethylene-propylene-styrene block copolymers (SEPS). This contributes to good adhesive properties and good mechanical stability. SIS, SBS or SEBS and mixtures thereof are particularly preferred. SBS may in particular be in the form of poly(styrene-b-butadiene-b-styrene). The SIS may in particular be in the form of poly(styrene-b-isoprene-b-styrene). The SEBS may in particular be in the form of poly(styrene-b-ethylene-butadiene-b-styrene). The SEPS may in particular be in the form of poly(styrene-b-ethylene-propylene-b-styrene).

Advantageously, the styrene-based thermoplastic elastomer of component C comprises a block copolymer. In this case, the hard phase and the soft phase are present in one molecule. This likewise contributes to good adhesive properties of the floor covering and high stability.

A further advantageous embodiment provides that the styrene-based thermoplastic elastomer of component C comprises a proportion of diblock copolymer. This likewise contributes to good adhesive properties of the floor covering and high stability. Preferably, the styrene-based thermoplastic elastomer comprises a proportion of polystyrene-diblock copolymer. It is preferred for the diblock proportion based on component C to be more than 5% and particularly preferably more than 10%. Particularly good properties are achieved for a diblock proportion based on component C of more than 15%. Advantageously, the diblock proportion based on component C is less than 75%.

Advantageously, it is provided that the styrene-based thermoplastic elastomer of component C comprises a triblock structure S-X-S, S being a styrene block and X being a block having elastomeric properties at 20° C. Preferably, the styrene block forms a vitreous or crystalline block at 20° C., which melts at higher temperatures. These measures contribute to good adhesive properties of the floor covering and high stability. In this context, the block X may form the soft phase and the styrene blocks S may form the hard phase of the thermoplastic elastomer.

An advantageous embodiment of the invention provides that component A comprises at least one olefin-based polymer selected from the group consisting of ethylene vinyl acetate (EVA), ethylene methacrylic acid (EMA), ethylene butyl acrylate (EBA), ethylene ethyl acrylate (EEA), ethylene propylene copolymer (EPM), very-low-density polyethylene (VLDPE), linear low-density polyethylene (LLDPE), polyolefin elastomer (POE), polyethylene (PE), polypropylene (PP), low-density polyethylene (LDPE) and polyolefin plastomer (POP). VLDPE has a density of between 0.880 g/cm³ and 0.915 g/cm³. LLDPE has a density of between 0.915 g/cm³ and 0.925 g/cm³. LDPE has a density of between 0.915 g/cm³ and 0.935 g/cm³. VLDPE, EVA or POE and mixtures thereof are particularly preferred according to the invention. Using these measures, particularly good adhesive properties of the floor covering and high mechanical stability can be achieved.

A further advantageous embodiment of the invention provides that the polymer comprised by component B is an ethylene-based polymer. Preferably, component B comprises polyethylene (PE), low-density polyethylene (LDPE) or ethylene vinyl acetate (EVA) or mixtures thereof. This contributes in particular to good mechanical stability together with good adhesive properties of the floor covering. LDPE has a density of between 0.915 g/cm³ and 0.935 g/cm³.

A further preferred embodiment of the invention provides that component B comprises styrene ethylene butylene styrene block copolymer (SEBS).

Particularly good adhesive properties of the floor covering are also achieved in that the polymer comprised by component B includes maleic acid anhydride groups and/or acrylic acid groups. Preferably, the maleic acid anhydride groups and/or the acrylic acid groups have been grafted onto the polymer. As a result, particularly good adhesive properties and high mechanical stability of the floor covering are achieved. In addition, the manufacture is simple and the process is highly reliable.

An advantageous embodiment provides that component B comprises a polymer which corresponds to the olefin-based polymer of component A and/or to the styrene-based thermoplastic elastomer of component C. This contributes to good adhesive properties of the floor covering and high stability.

A further advantageous embodiment provides that in component B the acid groups and/or anhydride groups grafted onto the polymer make up more than 1% by weight of component B. In this context, it is particularly preferred for the acid groups and/or anhydride groups to make up more than 1.5% by weight and in particular more than 2% by weight. In this context, it is preferred for the acid groups and/or anhydride groups to make up less than 8% by weight. Particularly good properties can be achieved if the acid groups make up more than 5% by weight. This is the case in particular if the acid groups comprise acrylic acid groups. The aforementioned levels of grafting contribute to good adhesive properties of the floor covering and high stability.

A further improvement can be achieved in that the polymer composition includes a filler. Preferably, the filler comprises at least one substance selected from the group consisting of chalk, silicic acid, silica, aluminium hydroxide, kaolin, sodium aluminium silicate, glass powder and wood flour. According to the invention, it is particularly preferred for the filler to comprise chalk. Preferably, the filler is contained in the polymer composition in a proportion by weight of between 50 and 500 based on the total amount of components A, B and C in the polymer composition. It is particularly preferred if the aforementioned weight proportion is between 150 and 300.

Advantageously, the polymer composition comprises processing agents. Preferably, the processing agents may comprise stearic acid and/or a resin, in particular a hydrocarbon resin. The processing agent may be provided in the polymer composition in particular in a proportion by weight of between 2 and 20 based on the total amount of components A, B and C in the polymer composition.

Unless stated otherwise, the specifications of proportions by weight of constituents of the polymer composition are in each case based on the total of components A, B and C in the polymer composition, which together make up 100 parts by weight.

Preferably, the polymer composition comprises an oil. Particular preferably, the oil is a synthetic oil. The oil may be provided in the polymer composition in particular in a proportion by weight of between 2 and 50 based on the total amount of components A, B and C. The oil contributes to improving the product properties and facilitating processing.

Preferably, the polymer composition comprises an anti-ageing agent.

Preferably, the polymer composition comprises a colourant. Preferably, the colourant contains inorganic and/or organic pigments. The colourant may be provided in the polymer composition in particular in a proportion by weight of between 1 and 40 based on the total amount of components A, B and C in the polymer composition.

An advantageous embodiment provides that the floor covering is formed as a web which has a usage face and a rear face. The rear face is applied to a subfloor during laying. In particular, the rear face can be adhered to the subfloor. The web is of a length and width which are each many times the thickness of the web. The web may for example be rolled into rolls. The web may further be in the form of tiles.

Preferably, the floor covering has at least one layer which contains the polymer composition and at least one further layer. The layer comprising the polymer composition may form a support layer of the floor covering.

Preferably, during manufacture, the at least one further layer is applied to the web.

A development of this inventive idea provides that the at least one further layer comprises a cover layer fixed to the usage face. The cover layer may in particular comprise a film of plastics material. The cover layer may form a wear layer of the floor covering. The cover layer may be laminated onto the support layer. Preferably, the cover layer is transparent. It is particularly preferred for the cover layer to be a transparent ionomer film. In particular, the film may be provided with an adhesive layer. The film provided with the adhesion layer and the support layer may be connected by laminating whilst supply heat and pressure. Preferably, the adhesive layer comprises at least one olefin-based polymer selected from the group consisting of ethylene vinyl acetate (EVA), ethylene methacrylic acid (EMA), ethylene butyl acrylate (EBA), ethylene ethyl acrylate (EEA), ethylene propylene copolymer (EPM), very-low-density polyethylene (VLDPE), linear low-density polyethylene (LLDPE), polyolefin elastomer (POE) and polyolefin plastomer (POP).

An advantageous embodiment provides that the at least one further layer comprises an adhesive layer applied to the rear face of the support layer. In this context, the adhesive may in particular be applied in advance.

Advantageously, the adhesive layer is provided with a removable covering. In this way, the floor covering provided with an adhesive layer can be manufactured in advance and stored without difficulty. During laying, the covering is removed and the floor covering can be adhered to a subfloor.

Preferably, a thickness of the floor covering is between 1 mm and 10 mm.

A preferred embodiment provides that components A, B and C are miscible.

According to the invention, it is preferred for component A to make up between 10 and 85 parts by weight based on the total of components A, B and C in the polymer composition. Preferably, component A makes up between 20 and 70 parts by weight. This contributes to good adhesive properties of the floor covering and high stability. Particularly preferably, component A makes up between 30 and 50 parts by weight.

Preferably, component B makes up between 1 and 40 parts by weight based on the total of components A, B and C in the polymer composition. Particularly preferably, component B makes up between 5 and 25 parts by weight. This contributes to good adhesive properties of the floor covering and high stability. Particularly preferably, component B makes up between 10 and 20 parts by weight.

Preferably, component C makes up between 10 and 85 parts by weight based on the total of components A, B and C in the polymer composition. Particularly preferably, component C makes up between 30 and 70 parts by weight. This contributes to good adhesive properties of the floor covering and high stability. Particularly preferably, component C makes up between 40 and 60 parts by weight.

A preferred embodiment of the invention provides that the density of the polymer composition is between 0.95 g/cm³ and 2.5 g/cm³. This contributes to good adhesive properties of the floor covering and high stability. In this context, the aforementioned densities are achieved partly in that the polymer composition contains fillers.

Preferably, the polymer composition does not contain chlorine-containing and/or halogen-containing compounds. Preferably, the polymer composition is free of polyvinyl chloride (PVC).

Preferably, the floor covering has a tensile strength of more than 5 N/mm². A tensile strength of more than 7.5 N/mm² is particularly preferred.

Preferably, the floor covering has an elongation at break of more than 25%. Particularly preferably, the elongation at break is more than 50%. The tensile strength and elongation at break are determined in the tension test according to DIN 53504 (version valid as of 1 Jul. 2015) on R1 specimens at 23° C.

Preferably, the floor covering has a tear propagation resistance of more than 25 N/mm. Particularly preferably, the tear propagation resistance is more than 35 N/mm. The tear propagation resistance may be determined by ISO 34-1, method B, procedure A (version valid as of 1 Jul. 2015).

Preferably, the Shore D hardness of the floor covering is between 35 and 60. A Shore D hardness of between 45 and 55 is particularly preferred. The Shore D hardness can be determined in accordance with DIN 53505 (version valid as of 1 Jul. 2015).

Preferably, the peel strength of the floor covering is more than 0.5 N/mm. A peel strength of more than 1.0 N/mm is particularly preferred. The peel strength is determined in accordance with EN 1372:2015. The adhesion may take place using the dispersion glue Wulff Supra-Strong on fibre cement plate. The measurement is preceded by at least two days of storage at room temperature.

Preferably, the viscosity of the polymer composition MVR/190/21.6 (test temperature 190° C., mass 21.6 kg) is between 3 and 100 cm³/10 min. A viscosity MVR/190/21.6 of between 10 and 50 cm³/10 min is particularly preferred. The MVR viscosity can be determined in accordance with ISO 1133 (version valid as of 1 Jul. 2015). This contributes among other things to good processability.

Preferably, the polymer composition is thermoplastic.

Preferably, during mixing, the temperature is between 100° C. and 180° C. This contributes to the melting of components A, B and C and facilitates and accelerates the mixing process.

Preferably, during mixing, energy is supplied to components A, B and C so as to melt components A, B and C. A supply of energy which increases the temperature can be provided by way of shear forces generated by the mixer during mixing. Alternatively or in addition, heat may also be supplied, for example by a heater before and/or during mixing.

Preferably, the shaping comprises calendering in a calendering system.

Preferably, the shaping comprises extrusion using a flat-sheet die head. The flat-sheet die head may in particular be part of a roller head system. In this context, the polymer composition is conveyed for example via a flat-sheet die head into the roller gap of a calender. The calender calibrates the material to the set final thickness.

Preferably, after shaping, the method comprises cooling the web. The cooling may take place in particular using cooling rollers.

Preferably, the shaping comprises structuring the surface, for example using an embossing roller.

Preferably, the mixing takes place in an internal mixer and/or in a mixing extruder.

A further improvement provides that the method comprises applying decorative particles after or during the shaping.

Preferably, after the shaping, the method comprises polishing the web. In particular, the rear face of the web may be grinded. This contributes to good adhesion values of the floor covering.

Preferably, after the shaping, the method comprises cutting the web to length. The web which has been cut to length can subsequently be laid as a plate or as a rolled material.

Preferably, it is provided that component A, component B and component C are each of a different composition.

Preferably, component A does not comprise any grafted polymers.

Preferably, component C does not comprise any grafted polymers.

The feature whereby component B comprises a polymer in which acid groups and/or anhydride groups are grafted onto the polymer is particular advantageous for the invention, but not compulsory. It is therefore explicitly also part of the subject matter of the disclosed invention to provide, for component B, a polymer having disclosed acid groups and/or anhydride groups, without the limitation that the acid groups and/or the anhydride groups are grafted onto the polymer. For example, component B may comprise a copolymer which has acid groups and/or anhydride groups.

Further aims, features, advantages and possible applications of the present invention may be derived from the following description of embodiments and from the drawings. All features which are disclosed and/or shown in the drawings, alone or in any reasonable combination, form the subject matter of the invention, regardless of how they are brought together in individual claims or the dependencies thereof.

In the drawings:

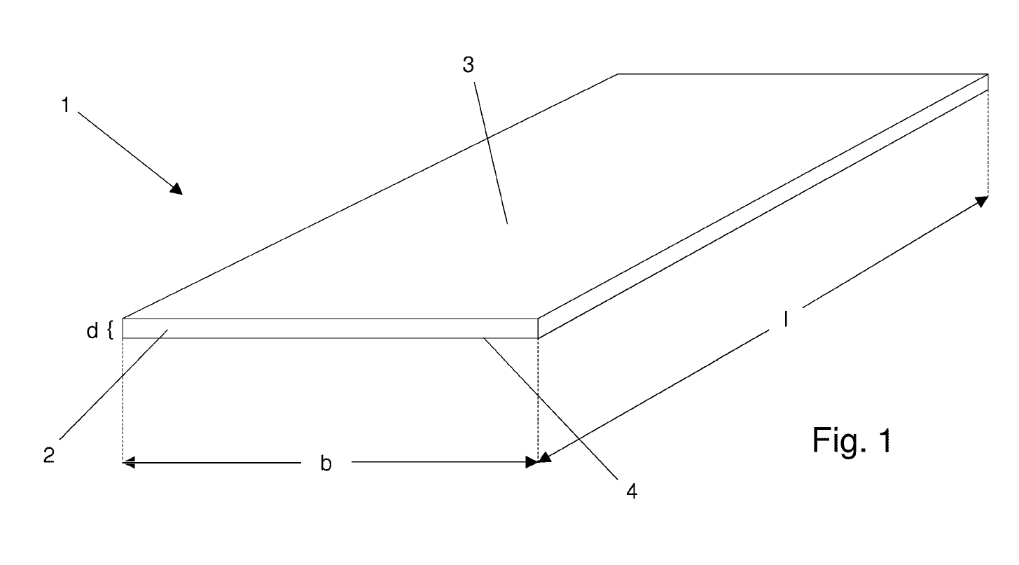

FIG. 1 is a schematic, perspective drawing of a floor covering according to the invention;

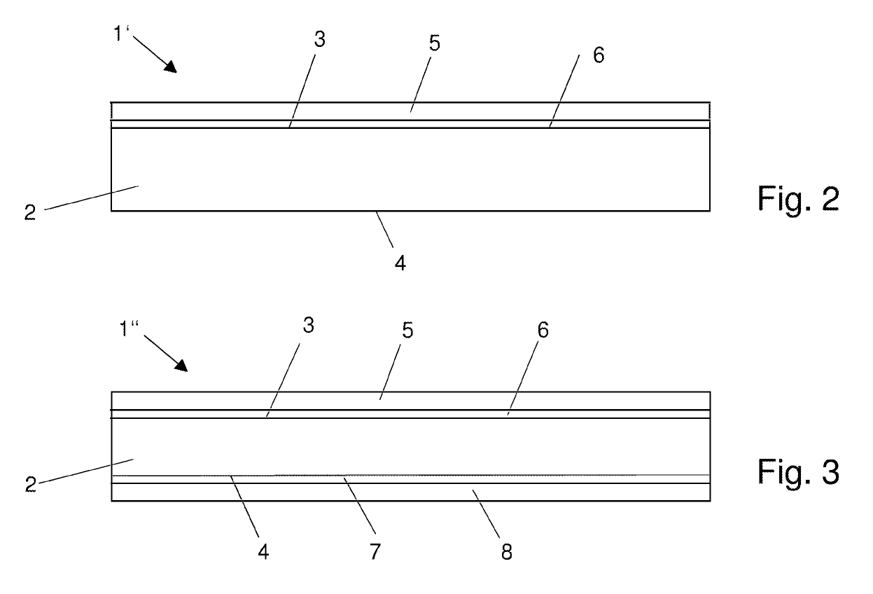

FIG. 2 is a schematic side view of a further embodiment of a floor covering according to the invention;

FIG. 3 is a schematic side view of another further embodiment of a floor covering according to the invention;

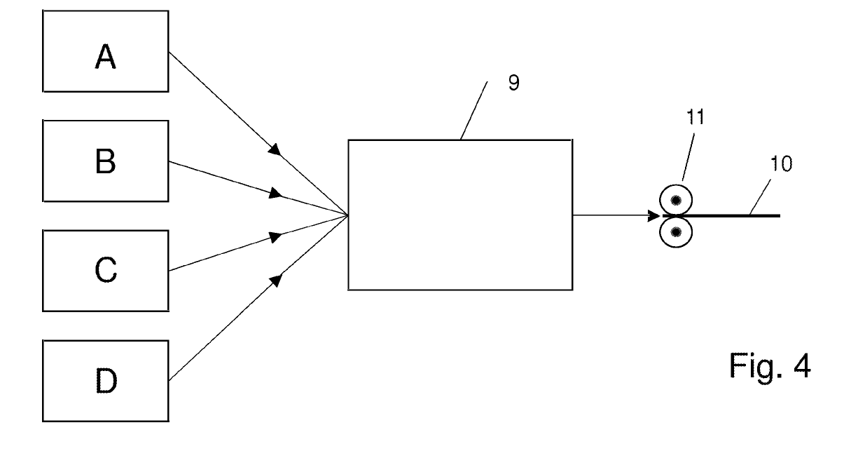

FIG. 4 is a schematic drawing of the method of manufacture.

FIG. 1 schematically shows a floor covering 1 according to the invention. The floor covering shown is a planar web, the thickness d of which is much less than the length l and the width b thereof. The thickness d may in particular be in the range of between 1 and 10 mm. The width b and the length l may be dimensioned in accordance with the desired delivery form of the floor covering. In particular, the floor covering may be delivered as a sheet product on a roller or as tiles.

The floor covering 1 has a support layer 2 comprising a polymer composition which is disclosed in greater detail below.

The support layer 2 comprises a usage face 3 and a rear face 4. During use of the floor covering as intended, the usage face 3 is arranged towards the room. The usage face may be formed as a decorative face. The rear face 4 is orientated towards the subfloor, for example towards the floor screed. The rear face 4 may be adhered to the subfloor using an adhesive for floor coverings, in particular using a dispersion adhesive.

FIG. 2 shows a floor covering 1′ which again has a support layer 2 made of a polymer composition. The support layer 2 is provided with a cover layer 5 on the usage face 3 thereof. In a preferred embodiment, the cover layer 5 is a transparent film. The cover layer 5 is durably connected to the support layer 2 via an adhesive layer 6. The cover layer 5 is resistant to normal stresses on a floor covering. In particular, the cover layer 5 may be formed by an ionomer film. Corresponding films may for example be made of the material Surlyn 1706 from DuPont. The adhesive layer may for example be made of Nucrel 0903 from DuPont. Nucrel 0903 comprises a copolymer of ethylene and methacrylic acid comprising an MA proportion of 9%. The cover layer 5 and the adhesive layer 6 may in particular be provided as a coextruded material having a thickness of approximately 200 μm and laminated onto the previously produced support layer 2 while supplying heat.

The representation in the drawings is merely intended to clarify the construction of the product. The representation is not to scale.

The construction shown in FIG. 3 of the floor covering 1″ corresponds to that of FIG. 2 for the support layer 2 and the usage face 3. Reference is made to the corresponding description. In addition, the floor covering 1″ has on the rear face 4 an adhesive layer 7, which is applied in advance. The adhesive layer 7 is provided with a removable covering 8. The floor covering 1″ may be adhered to a subfloor, without it being necessary for an adhesive to be applied during laying. It is sufficient to remove the covering 8 during the laying and to bring the floor covering 1″ provided with the adhesive layer 7 into contact with the subfloor.

FIG. 4 schematically shows the manufacture of the floor covering. Initially, components A, B and C are provided. These may in particular be the substances specified in the embodiments set out below. For example, in accordance with embodiment 24, 15 parts by weight VLDPE 1, 10 parts by weight POE 1 and 15 parts by weight EVA 1 may be provided as component A. In accordance with embodiment 24, 20 parts by weight MAH-LDPE2 may be provided as component B. In accordance with embodiment 24, 40 parts by weight SIS 1 may be provided as component C.

In addition, the further components of the polymer composition are provided. These are jointly denoted as D. The further components may in particular be fillers, processing agents, oil, anti-ageing agents and/or colourants. For example, in accordance with embodiment 24, 300 parts by weight filler (FL), 4.5 parts by weight oil (OIL), 0.5 parts by weight processing agent (PA) and 0.5 parts by weight anti-ageing agent (AAA) may be provided.

Components A, B and C and the further components D are added into a mixer 9 together and thoroughly mixed together. The mixer 9 may for example be formed as an internal mixer or as a mixing extruder. During mixing, the heat for melting components A, B and C may be generated by shear forces. The shear forces in the material are generated by the mixing process. Alternatively or in addition, heat may be supplied, for example by a heater. The mixing process is carried out until the melted polymers of components A, B and C form a unitary mass. For example, the temperature during mixing may be between 100° C. and 180° C. In order for the desired temperature range not to be exceeded, cooling may be provided which dissipates excess heat which occurs during mixing.

After mixing, the polymer composition is shaped into a web 10. The shaping may take place for example using an extruder comprising a flat-sheet die head and/or by calendering in a calendering system 11. Preferably, the polymer composition is initially extruded through an extruder comprising a flat-sheet die head and subsequently additionally brought to the desired thickness by calendering.

The calendering takes place in particular in a warm state in which the composition is already dimensionally stable but can be plastically deformed easily. Subsequently, the web 10 is cooled, for example to less than 60° C. The cooling may in particular take place using cooling rollers.

To produce visually appealing floor coverings, decorative granulates may be scattered on the usage face 3 of the web 10. Decorative granulates may be applied in particular before and/or during shaping. The usage face 3 may also additionally be provided with a decor in another manner.

If the floor covering 1 has a further layer, this may be applied to the web 10. For example, a cover layer 5 comprising the adhesion layer 6 may be laminated onto the web 10 which forms the support layer 2, so as to achieve the floor covering shown in FIG. 2. Further, an adhesive layer 7 and a covering 8 may be applied to the rear face 4, so as to achieve the floor covering shown in FIG. 3. The covering 8 may comprise a siliconized HDPE film.

To achieve improved adhesion, the rear face 4 may be grinded. If the floor covering is provided with an adhesive layer 7, the grinding takes place before the adhesive layer 7 is applied.

Hereinafter, a series of examples of the polymer composition are disclosed. Further, a peel strength is specified for each example. The peel strength is determined in accordance with standard EN 1372:2015. In this context, the adhesion took place using the dispersion adhesive Wulff Supra-Strong on fibre cement plate. The measurement was preceded by two days of storage at room temperature. The tensile strength and elongation at break are also specified in each case. These are determined in the tension test according to DIN 53504 on R1 specimens at 23° C. In addition, the tables contain specifications of the tear propagation resistance, which is determined in accordance with standard ISO 34-1, method B, procedure A. The Shore D hardness is determined in accordance with standard DIN 53505. The MVR viscosity is determined in accordance with standard DIN EN ISO 1133. In each case, the specifications are based on the versions of the standards valid as of 1 Jul. 2015. The glass transition temperature T_{G} is determined in accordance with DIN EN ISO 11357-2, version valid as of 1 Jul. 2015. The stated values are determined by the half-step-height method in each case.

The following components are constituents of the polymer compositions specified by way of example:

Component A

VLDPE 1 denotes a VLDPE. The product is available under the name Clearflex CL DO (versalis).

POE 1 denotes a POE available under the product name Exact 8210 (Exxon). The product contains an ethylene octane copolymer.

EVA 1 denotes an EVA available under the product name Greenflex ML50 (versalis). The proportion of copolymerised vinyl acetate (VA) is 19%.

Component B

MAH-EVA 1 denotes an EVA grafted with maleic acid anhydride (MAH). The product is available under the product name Fusabond C250 (DuPont). The proportion of copolymerised vinyl acetate is 28%. The proportion of MAH is 1.5% by weight.

MAH-LDPE 1 denotes a LDPE grafted with maleic acid anhydride (MAH). The product is available under the product name Scona TSPE 1112 GALL (BYK).

The LDPE is grafted with 2% by weight MAH.

MAH-LDPE 2 denotes a further LDPE grafted with maleic acid anhydride (MAH). The product is available under the product name Fusabond E226 (DuPont). The LDPE is grafted with 1% by weight MAH.

AA-LDPE 1 denotes a LDPE grafted with acrylic acid (AA). The product is available under the product name Scone TPPE 2611 PALL (BYK). The LDPE is grafted with 6% by weight AA.

MAH-EVA 2 denotes an EVA grafted with maleic acid anhydride (MAH). The product is available under the name Scona TPEV 1112 PB (BYK). The EVA is grafted with 2.5% by weight MAH.

AA-EVA 1 denotes an EVA grafted with acrylic acid (AA). The product is available under the product name Scona TPEV 1110 PB (BYK). The EVA is grafted with 2% by weight AA.

MAH-SEBS 1 denotes an SEBS grafted with maleic acid anhydride (MAH). The product is available under the product name Scona TSKD 9103 (BYK). The SEBS is grafted with 1.5% by weight MAH.

Component C

SIS 1 denotes a thermoplastic elastomer comprising styrene isoprene styrene (SIS). The product is available under the product name Hybrar 5127 (Kuraray). SIS 1 contains isoprene monomers built in the polymer chain as 1,2-vinyl isomers. The proportion of isoprene groups in vinyl position is more than 70% by weight. The glass transition temperature T_{G} of the soft phase is +8° C.

SIS 2 denotes a thermoplastic elastomer comprising styrene isoprene styrene (SIS). The product is available under the product name Europrene SOL T9326 (versalis). The styrene proportion is 30%. The diblock proportion is 20%. The glass transition temperature T_{G} of the soft phase is −56° C.

SEBS denotes a SEBS. The product is available under the product name Europrene SOL TH2311 (versalis). The styrene proportion is 30%. The glass transition temperature T_{G} of the soft phase is −50° C.

SBS 1 denotes a SBS. This is available under the product name Styroflex 2 G 66 (Styrolution). The styrene proportion is 60%. SBS 1 contains styrene in the soft phase. For this purpose, the product contains styrene/butadiene copolymer blocks. The glass transition temperature T_{G} of the soft phase is −39° C.

SBS 2 denotes a SBS. This is available under the product name Europrene SOL T166 (versalis). In this product, the diblock proportion is 10%. The styrene proportion is 30%. The glass transition temperature T_{G} of the soft phase is −118° C.

SBS 3 denotes a SBS. This is available under the product name Europrene SOL T6414 (versalis). In this product, the diblock proportion is 22%. The styrene proportion is 40%. The glass transition temperature T_{G} of the soft phase is −117° C.

Further Components of the Polymer Composition

FL denotes a filler. In the recipe examples, chalk is used as a filler.

OIL denotes an oil. In the recipe examples, synthetic oil is used.

PA denotes a processing agent. In the examples shown, stearic acid is used as a processing agent.

AAA denotes an anti-ageing agent. In the examples, Irganox 1010 (BASF) is used as an anti-ageing agent.

In the tables, proportions by weight are specified for the individual components. The specifications are each based on the total of the components A, B and C of the polymer composition, which together make up 100 parts by weight.

Table 1 shows examples 1-6. Of these, examples 1 and 2 are comparative examples, whilst embodiments 3 to 6 are in accordance with the invention. The polymer composition contains VLDPE 1 as component A in each case. Examples 1 and 3 to 6 contain MAH-EVA 1 as component B in each case. Further, examples 2 to 6 each contain SBS 1 or SIS 1 as component C. Further, the embodiments shown in Table 1, as well as those shown in the further tables, each comprise filler (FL), synthetic oil (OIL), processing agent (PA) and anti-ageing agent (AAA). The measurement values reproduced in the lower part of the table show that embodiments 3 to 6 have good mechanical properties together with a usable peel strength. Here, the peel strength is a measure of the adhesive properties of the floor covering. For good adhesion of the floor covering to the subfloor, it is desirable for the peel strength to be 0.5 N/mm or more. Embodiment 3 is indeed slightly below this, at 0.4 N/mm. However, it is clear from Table 1 that, by comparison with examples 1 and 2, embodiments 3 to 6 have greatly improved mechanical properties, which are reflected in the measurement values for tensile strength, elongation at break, tear propagation resistance and hardness. In this context, it is advantageous for the tear propagation resistance for a floor covering to be 25 N/mm or more. In embodiments 3 to 6, the tensile strength is consistently below 5 N/mm². This results in good usability as a floor covering. It can further be seen from Table 1 that embodiments 3 to 6 a have greatly improved elongation at break. This should be more than 25% for resilient floor coverings. It can further be seen that embodiment 6 contains 40 parts SIS 1. The peel strength and the elongation at break are thus greatly increased, whilst good tensile strength and tear propagation resistance values are still achieved.

TABLE 1

| | 1 | 2 | 3 | 4 | 5 | 6 |
|---|---|---|---|---|---|---|
| VLDPE 1 | 80 | 50 | 60 | 60 | 40 | 40 |
| MAH-EVA 1 | 20 | | 20 | 20 | 20 | 20 |
| SBS 1 | | 50 | 20 | | 40 | |
| SIS 1 | | | | 20 | | 40 |
| FL | 300 | 300 | 300 | 300 | 300 | 300 |
| OIL | 18 | 18 | 18 | 18 | 18 | 18 |
| PA | 2 | 2 | 2 | 2 | 2 | 2 |
| AAA | 0.5 | 0.5 | 0.5 | 0.5 | 0.5 | 0.5 |
| Peel strength | 0.2 | 0.6 | 0.4 | 0.5 | 0.5 | 0.8 |
| [N/mm] | | | | | | |
| Tensile | 4.9 | 3.2 | 5.4 | 5.5 | 5.8 | 5.4 |
| strength | | | | | | |
| [N/mm²] | | | | | | |
| Elongation at | 10 | 14 | 27 | 34 | 28 | 60 |
| break [%] | | | | | | |
| Tear propaga- | 20 | 18 | 24 | 25 | 27 | 23 |
| tion resistance | | | | | | |
| [N/mm] ISO | | | | | | |
| Hardness | 37 | 29 | 37 | 37 | 39 | 36 |
| [Shore D] | | | | | | |
| MVR | >200 | >200 | >200 | >200 | >200 | >200 |
| [cm³/10 min] | | | | | | |
| 190° C./ | | | | | | |
| 21.6 kg | | | | | | |

Table 2 shows further examples 7 to 11. Of these, examples 7 and 8 are comparative examples, whilst embodiments 9 to 11 are in accordance with the invention. The polymer compositions each contain a mixture of VLDPE 1, POE 1 and EVA 1 as component A. MAH-LDPE 1 is provided for component B in each case. The polymer compositions of embodiments 2 to 6 contain SBS 1 or SIS 1 as component C.

Examples 9, 10 and 11 show that improved values of well over 0.5 N/mm can be achieved for the peel strength. At the same time, the mechanical values of the floor covering, such as in particular the tensile strength, the elongation at break and the tear propagation resistance are much higher than in the embodiments of Table 1. The hardness is also in a favourable range for floor coverings. By contrast, examples 7 and 8, which each only contain either component B or component C, only achieve a peel strength well below that of examples 9 to 11.

TABLE 2

| | 7 | 8 | 9 | 10 | 11 |
|---|---|---|---|---|---|
| VLDPE 1 | 30 | 25 | 20 | 15 | 15 |
| POE 1 | 25 | 20 | 15 | 10 | 10 |
| EVA 1 | 30 | 25 | 20 | 15 | 15 |
| MAH-LDPE 1 | 15 | | 15 | 15 | 15 |
| SBS 1 | | 30 | | 45 | |
| SIS 1 | | | 30 | | 45 |
| FL | 300 | 300 | 300 | 300 | 300 |
| OIL | 18 | 18 | 18 | 18 | 18 |
| PA | 2 | 2 | 2 | 2 | 2 |
| AAA | 0.5 | 0.5 | 0.5 | 0.5 | 0.5 |
| Peel strength [N/mm] | 0.2 | 0.3 | 0.6 | 0.6 | 0.7 |
| Tensile strength [N/mm²] | 7.4 | 6.2 | 7.0 | 7.5 | 7.0 |
| Elongation at break [%] | 60 | 25 | 65 | 46 | 61 |
| Tear propagation resistance | 40 | 27 | 35 | 36 | 35 |
| [N/mm] ISO | | | | | |
| Hardness [Shore D] | 43 | 39 | 42 | 45 | 42 |
| MVR [cm³/10 min] | 55 | 38 | 71 | 46 | 103 |
| 190° C./21.6 kg | | | | | |

Table 3 shows examples 12 to 19. Of these, example 12 is a comparative example, whilst embodiments 13 to 19 are in accordance with the invention. In each case, a mixture of VLDPE 1, POE 1 and EVA 1 is provided as component A. Component B is MAH-LDPE 1 in each case. The polymer compositions comprise SBS 1, SBS 2, SBS 3, SIS 1, SIS 2 or SEBS 1 as component C.

It is clear from Table 3 that particularly good adhesion values (peel strength) are achieved in embodiments 13 to 19. These are even well over 1 N/mm in some cases. At the same time, it was possible further to improve the tensile strength and tear propagation resistance values. The hardness is also in a particularly favourable range for floor coverings of between Shore D 45 and 55.

TABLE 3

| | 12 | 13 | 14 | 15 | 16 | 17 | 18 | 19 |
|---|---|---|---|---|---|---|---|---|
| VLDPE 1 | 30 | 15 | 15 | 15 | 15 | 15 | 15 | 15 |
| POE 1 | 25 | 10 | 10 | 10 | 10 | 10 | 10 | 10 |
| EVA 1 | 30 | 15 | 15 | 15 | 15 | 15 | 15 | 15 |
| MAH-LDPE 1 | 15 | 15 | 15 | 15 | 15 | 15 | 15 | 15 |
| SBS 1 | | 45 | | | | | | 15 |
| SBS 2 | | | | 45 | | | | |
| SBS 3 | | | | | | 45 | | |
| SIS 1 | | | 45 | | | | | 30 |
| SIS 2 | | | | | | | 45 | |
| SEBS 1 | | | | | 45 | | | |
| FL | 300 | 300 | 300 | 300 | 300 | 300 | 300 | 300 |
| OIL | 4.5 | 4.5 | 4.5 | 4.5 | 4.5 | 4.5 | 4.5 | 4.5 |
| PA | 0.5 | 0.5 | 0.5 | 0.5 | 0.5 | 0.5 | 0.5 | 0.5 |
| AAA | 0.5 | 0.5 | 0.5 | 0.5 | 0.5 | 0.5 | 0.5 | 0.5 |
| Peel strength [N/mm] | 0.3 | 0.7 | 1.3 | 1.0 | 0.8 | 0.9 | 1.0 | 1.2 |
| Tensile strength [N/mm²] | 8.9 | 9.7 | 9.1 | 7.9 | 9.5 | 8.6 | 7.9 | 8.9 |
| Elongation at break [%] | 41 | 27 | 50 | 50 | 24 | 18 | 81 | 51 |
| Tear propagation | 52 | 58 | 51 | 42 | 59 | 53 | 47 | 50 |
| resistance [N/mm] ISO | | | | | | | | |
| Hardness [Shore D] | 51 | 51 | 49 | 48 | 50 | 51 | 47 | 53 |
| MVR [cm³/10 min] | 21 | 23 | 31 | 14 | 3 | 16 | 22 | 16 |
| 190° C./21.6 kg | | | | | | | | |

Table 4 shows embodiments 20 to 25 according to the invention. Table 4 thus shows polymer compositions containing a mixture of VLDPE 1, POE 1 and EVA 1 as component A in each case. The mixtures contain MAH-LDPE 1, MAH-LDPE 2, AA-LDPE 1, MAH-EVA 2, AA-EVA 1 or MAH-SEBS 1 as component B. SIS 1 is provided as component C in each case.

The table shows that very good adhesion values (peel strength) of above 1 N/mm can be achieved in each case. The further mechanical values, such as tensile strength and tear propagation resistance, are also at a high level. The elongation at break is also at a good level. The table shows, among other things, that good results can be achieved both using a component B comprising acid groups and using a component B comprising anhydride groups. Embodiments 20, 22, 24 and 25, which each comprise polymers grafted with maleic acid anhydride groups, thus have good values over all parameters. However, good values can also be achieved in the compositions containing polymers grafted with acrylic acid groups. Table 4 demonstrates that very good values for the floor covering can be achieved using polymer compositions containing isoprene monomers built in the polymer chain as 1,2-vinyl isomers as component C and grafted polymers as component B.

TABLE 4

| | 20 | 21 | 22 | 23 | 24 | 25 |
|---|---|---|---|---|---|---|
| VLDPE 1 | 15 | 15 | 15 | 15 | 15 | 20 |
| POE 1 | 10 | 10 | 10 | 10 | 10 | 15 |
| EVA 1 | 15 | 15 | 15 | 15 | 15 | 20 |
| MAH-LDPE 1 | 20 | | | | | |
| MAH-LDPE 2 | | | | | 20 | |
| AA-LDPE 1 | | 20 | | | | |
| MAH-EVA 2 | | | 20 | | | |
| AA-EVA 1 | | | | 20 | | |
| MAH-SEBS 1 | | | | | | 20 |
| SIS 1 | 40 | 40 | 40 | 40 | 40 | 25 |
| FL | 300 | 300 | 300 | 300 | 300 | 300 |
| OIL | 4.5 | 4.5 | 4.5 | 4.5 | 4.5 | 4.5 |
| PA | 0.5 | 0.5 | 0.5 | 0.5 | 0.5 | 0.5 |
| AAA | 0.5 | 0.5 | 0.5 | 0.5 | 0.5 | 0.5 |
| Peel strength [N/mm] | 1.0 | 1.1 | 1.1 | 1.2 | 1.1 | 1.0 |
| Tensile strength [N/mm²] | 8.9 | 8.4 | 7.6 | 7.5 | 9.2 | 9.0 |
| Elongation at break [%] | 56 | 40 | 39 | 44 | 67 | 47 |
| Tear propagation | 49 | 41 | 37 | 36 | 47 | 37 |
| resistance [N/mm] ISO | | | | | | |
| Hardness [Shore D] | 52 | 51 | 48 | 47 | 51 | 48 |
| MVR [cm³/10 min] | 19 | 42 | 25 | 24 | 8 | 16 |
| 190° C./21.6 kg | | | | | | |

1. A floor covering containing a polymer composition comprising a mixture of a component A, a component B and a component C, component A comprising an olefin-based polymer, component B comprising a polymer and component C comprising a styrene-based thermoplastic elastomer, characterised in that the polymer of component B comprises acid groups and/or anhydride groups which are grafted onto the polymer.

2. The floor covering according to claim 1, wherein the styrene-based thermoplastic elastomer comprises a hard phase and a soft phase, and in that the soft phase has a glass transition temperature T_{G} of −50° C. or higher.

3. The floor covering according to claim 2, the soft phase comprises styrene.

4. The floor covering according to claim 1, wherein the styrene-based thermoplastic elastomer comprises an isoprene monomer built in the polymer chain as 1,2-vinyl isomer.

5. The floor covering according to claim 1, wherein the styrene-based thermoplastic elastomer has a styrene content of between 15% by weight and 80% by weight.

6. The floor covering according to claim 1, wherein the styrene-based thermoplastic elastomer comprises at least one compound from the group consisting of styrene-butadiene-styrene block copolymers (SBS), styrene-isoprene-styrene block copolymers (SIS), styrene-ethylene-butylene-styrene block copolymers (SEBS) and styrene-ethylene-propylene-styrene block copolymers (SEPS).

7. The floor covering according to claim 1, the styrene-based thermoplastic elastomer comprises a block copolymer.

8. The floor covering according to claim 1, wherein the styrene-based thermoplastic elastomer comprises a proportion of diblock copolymer.

9. The floor covering according to claim 1, wherein the styrene-based thermoplastic elastomer comprises a triblock structure S-X-S, S being a styrene block and X being a block having elastomeric properties at 20° C.

10. The floor covering according to claim 1, wherein component A comprises at least one olefin-based polymer selected from the group consisting of ethylene vinyl acetate, ethylene methacrylic acid, ethylene butyl acrylate, ethylene ethyl acrylate, ethylene propylene copolymer, very-low-density polyethylene, linear low-density polyethylene, polyolefin elastomer, polyethylene, polypropylene, low-density polyethylene and polyolefin plastomer.

11. The floor covering according to claim 1, wherein maleic acid anhydride groups and/or acrylic acid groups are grafted onto the polymer comprised by component B.

12. The floor covering according to claim 1, wherein the component B comprises a polymer which matches the olefin-based polymer of component A and/or to the styrene-based thermoplastic elastomer of component C.

13. The floor covering according to claim 1, wherein in component B the acid groups and/or anhydride groups grafted onto the polymer make up more than 1% by weight of component B.

14. The floor covering according to claim 1, wherein the floor covering has at least one layer which contains the polymer composition and at least one further layer.

15. A method for manufacturing a floor covering, comprising the following steps:
providing a component A, a component B and a component C, component A comprising an olefin-based polymer, component B comprising a polymer in which acid groups and/or anhydride groups are grafted onto the polymer, and component C comprising a styrene-based thermoplastic elastomer;
manufacturing a polymer composition by mixing component A, component B and component C in a mixer;
shaping the polymer composition into a web.

16. A method according to claim 15, wherein component A makes up between 10 and 85 parts by weight based on the total of components A, B and C in the polymer composition.

17. A method according to either claim 15, wherein component B makes up between 1 and 40 parts by weight based on the total of components A, B and C in the polymer composition of the polymer composition.

18. The method according to claim 15, wherein component C makes up between 10 and 85 parts by weight based on the total of components A, B and C in the polymer composition of the polymer composition.
